(19) United States
(12) Patent Application Publication
(10) Pub. No.: US 2025/0260349 A1
(43) Pub. Date: Aug. 14, 2025

(54) CONTROL DEVICE

(71) Applicant: TOYOTA JIDOSHA KABUSHIKI KAISHA, Toyota-shi (JP)

(72) Inventors: Koh OHNO, Toyota-shi (JP); Toshifumi YAMAKAWA, Okazaki-shi (JP); Hideto HANADA, Okazaki-shi (JP)

(73) Assignee: TOYOTA JIDOSHA KABUSHIKI KAISHA, Toyota-shi (JP)

(21) Appl. No.: 18/986,747

(22) Filed: Dec. 19, 2024

(30) Foreign Application Priority Data
Feb. 13, 2024 (JP) 2024-019710

(51) Int. Cl. H02P 21/22; B60L 15/20

(52) U.S. Cl. CPC H02P 21/22; B60L 15/20; H02P 2207/05

(57) ABSTRACT

In a control device mounted on a vehicle provided with a traction motor, and including a processing unit and a storage unit, the processing unit sets a stored value stored in the storage unit to a predetermined parameter related to the drive control of the motor when reaching the first predetermined timing, and executes the estimation processing for this time for the estimated value related to the predetermined parameter using the stored value as an initial value, and when reaching the second predetermined timing, stores the estimated value in the estimation processing for this time as a stored value in the storage unit.

### CROSS-REFERENCE TO RELATED APPLICATION

This application claims priority to Japanese Patent Application No. 2024-019710 filed on Feb. 13, 2024, incorporated herein by reference in its entirety.

### BACKGROUND

### 1. Technical Field

The present disclosure relates to a control device.

### 2. Description of Related Art

Conventionally, a control device that generates a voltage command value by a current control unit, from a current command value and a detected current value from a current sensor, has been proposed. The control device inputs the voltage command value to a plant model unit to calculate a virtual current value. The control device calculates a compensation value by inputting the virtual current value to a periodic disturbance observer via a coordinate transformation unit. The control device corrects the detected current value of the current sensor by superimposing the compensation value that is calculated on the detected current value via a coordinate inverse transformation unit (e.g., see Japanese Unexamined Patent Application Publication No. 2015-69439 (JP 2015-69439 A)). In this control device, offset error and gain error are calculated by inputting a value obtained by superimposing the detected current value and the compensation value, and the detected current value, to a current sensor error estimation unit, and error of the current sensor is estimated based on the error signals that are calculated.

### SUMMARY

In such a control device, when a portion of various types of parameters related to drive control of a motor is sequentially updated, in some control devices, stability of drive control of the motor may deteriorate due to updating the parameter to a value with great error or the like.

A main object of the control device of the present disclosure is to suppress deterioration in stability of drive control of a motor.

In order to achieve the above primary object, the control device of the present disclosure employs the following measures.

[1] A control device according to an aspect of the present disclosure is a control device installed in a vehicle equipped with a traction motor, the control device including a processing unit and a storage unit, in which the processing unit,
upon reaching a first predetermined timing, sets a stored value that is stored in the storage unit to a predetermined parameter related to drive control of the motor, and also executes estimation processing for this time regarding an estimated value related to the predetermined parameter, using the stored value as an initial value, and
upon reaching a second predetermined timing, the estimated value in the estimation processing for this time is stored in the storage unit as the stored value.

In the control device according to the present disclosure, when the first predetermined timing is reached, the processing unit sets the stored value stored in the storage unit to the predetermined parameter related to the drive control of the motor. The processing unit uses the stored value as the initial value to execute the estimation processing for this time for the estimated value related to the predetermined parameter. Also, when the second predetermined timing is reached, the processing unit causes the storage unit to store the estimated value in the estimation processing for this time as the stored value. Accordingly, the processing unit sets the stored value to the predetermined parameter each time the first predetermined timing is reached. That is to say, the processing unit holds the predetermined parameter from reaching the first predetermined timing for this time until reaching the first predetermined timing for the next time. Thus, the processing unit circumvents successive updating (frequent updating) of the predetermined parameter. This can suppress deterioration in stability of drive control of the motor. Also, by executing the estimation processing for this time for the estimated value related to the predetermined parameter, using the stored value as the initial value, the time until the estimated value converges in the estimation processing for this time can be suppressed from being long.

Now, the predetermined parameter may be a parameter regarding which a steep change is assumed to be unlikely. Specifically, the predetermined parameter may be a parameter that is assumed to have a gradual change characteristic (a change characteristic in which a change rate, which is a change amount per unit time, is no greater than a predetermined change rate) at an interval between the first predetermined timing and the second predetermined timing, or at an interval between the first predetermined timing for this time and the first predetermined timing for the next time. The present inventors have, through diligent study, confirmed that, with respect to a parameter that is assumed to be unlikely to exhibit steep change, stability of drive control of the motor is readily deteriorated by successive updating. The estimation processing for the predetermined parameter may be processing in which convergence of the estimated value is prioritized in comparison with responsivity as to a vicinity of a true value, and specifically may be processing in which the responsivity as to the vicinity of the true value is low but the convergence of the estimated value is good.

[2] In the control device of the present disclosure (the control device according to [1] above),
upon reaching the second predetermined timing, the processing unit may store the estimated value as the stored value in the storage unit when the estimated value in the estimation processing for this time is within an allowable range, and may not store the estimated value in the storage unit when the estimated value in the estimation processing for this time is outside the allowable range.

[3] In the control device of the present disclosure (the control device according to [1] or [2] above),
the first predetermined timing may include at least one of a timing at which system booting of the vehicle is instructed, a timing at which the vehicle is stopped by a brake operation, and a timing at which a torque command used for drive control of the motor crosses a torque threshold, and
the second predetermined timing may include at least one of a timing at which system shutdown of the vehicle is instructed, and a timing at which a predetermined time elapsed from the first predetermined timing.

[4] In the control device of the present disclosure (the control device according to any one of [1] to [3] described above),
the predetermined parameter may be a correction value based on at least one of a gain error of a current sensor that detects a phase current of each phase of the motor, and an offset error of the current sensor.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a battery electric vehicle 20 including a control device according to an embodiment;

FIG. 2 is a flow chart illustrating an exemplary process routine executed by CPU 51 of the electronic control unit 50;

FIG. 3 is an explanatory diagram illustrating an exemplary state of the correction value ΔId and the correction estimated value ΔIdc; and

FIG. 4 is a flowchart illustrating an example of a processing routine according to a modification.

### DETAILED DESCRIPTION OF EMBODIMENTS

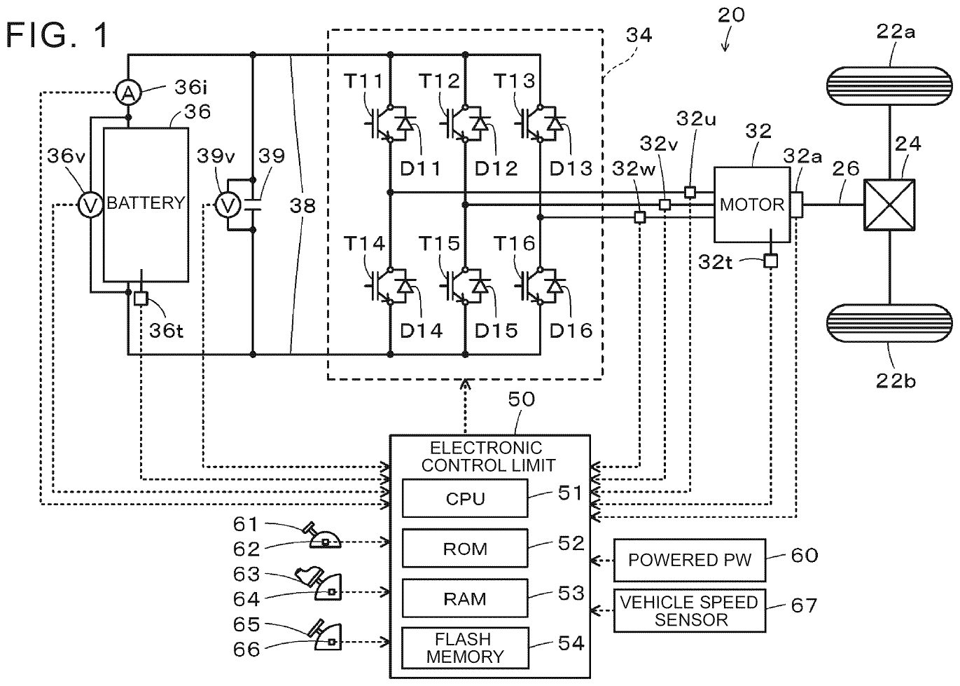

Embodiments for carrying out the present disclosure will be described with reference to the drawings. FIG. 1 is a schematic configuration diagram of a battery electric vehicle 20 including a control device according to an embodiment of the present disclosure. As illustrated, battery electric vehicle 20 of the embodiment includes a motor 32, an inverter 34, a battery 36 as a power storage device, and an electronic control unit 50 as a control device.

The motor 32 is configured as a three-phase AC motor, and includes a rotor in which a permanent magnet is embedded in a rotor core, and a stator in which a three-phase coil is wound around the stator core. The rotor of the motor 32 is connected to a drive shaft 26 connected to the drive wheels 22a, 22b via a differential gear 24.

The inverter 34 is used to drive the motor 32 and is connected to the battery 36 via a power line 38. The inverter 34 includes transistors T11-T16 as six switching elements and six diodes D11-D16 connected in parallel to the six transistors T11-T16. Transistors T11-T16 are arranged in pairs of two so as to be source side and sink side with respect to the positive line and negative line of the power line 38, respectively. Each of the connecting points of the transistors as paired transistors T11-T16 is connected to each of the three-phase (U-phase, V-phase, W-phase) coils of the motor 32. Thus, the electronic control unit 50 adjusts the rate of on-time of the paired transistors T11-T16 when the inverter 34 is energized. Thus, a rotating magnetic field is formed in the three-phase coil of the motor 32. The motor 32 (rotor) is rotationally driven.

The battery 36 is configured as, for example, a lithium-ion secondary battery or a nickel-hydrogen secondary battery, and is connected to the inverter 34 via the power line 38 as described above. A smoothing capacitor 39 is attached to the positive electrode line and the negative electrode line of the power line 38.

The electronic control unit 50 includes a microcomputer having a CPU 51, ROM 52, RAM 53, a flash memory 54, an input/output port, and a communication port. The electronic control unit 50 receives signals from various sensors via input ports. For example, the electronic control unit 50 receives the rotational position θm from the rotational position sensor 32a that detects the rotational position of the rotor of the motor 32, the phase currents Iu, Iv, Iw from the current sensors 32u, 32v, 32w that detects the phase current of each phase of the motor 32, and the temperature am from the temperature sensor 32t that detects the temperature of the motor 32. The electronic control unit 50 also receives a voltage Vb from a voltage sensor 36v mounted between terminals of the battery 36, a current Ib from a current sensor 36i mounted to an output terminal of the battery 36, a temperature at from a temperature sensor 36t mounted to the battery 36, and a voltage VH of a capacitor 39 (power line 38) from a voltage sensor 39a mounted between terminals of the capacitor 39. The electronic control unit 50 also receives an on-off signal from the power switch 60, a shift position SP from the shift sensor 62 for detecting the operation position of the shift lever 61, an accelerator operation amount Acc from the accelerator pedal position sensor 64 for detecting the depression amount of the accelerator pedal 63, a brake pedal position BP from the brake pedal position sensor 66 for detecting the depression amount of the brake pedal 65, and a vehicle speed V from the vehicle speed sensor 67.

The electronic control unit 50 outputs various control signals via an output port. For example, the electronic control unit 50 outputs a control signal to the transistors T11-T16 of the inverter 34. The electronic control unit 50 calculates the electric angle θe and the rotational speed Nm of the motor 32 based on the rotational position θm of the rotor of the motor 32 from the rotational position sensor 32a. The electronic control unit 50 calculates the power storage ratio SOC of the battery 36 based on the integrated value of the current Ib of the battery 36 from the current sensor 36i.

In battery electric vehicle 20 of the embodiment thus configured, the electronic control unit 50 (CPU 51) sets the required torque Td* required for the drive shaft 26 based on the accelerator operation amount Acc and the vehicle speed V. The electronic control unit 50 sets the set required torque Td* to the torque command Tm* of the motor 32 so as to be outputted to the drive shaft 26. The electronic control unit 50 performs switching control of the transistors T11-T16 of the inverter 34 so that the motor 32 is driven by the torque command Tm *.

The electronic control unit 50 basically controls the inverter 34 by pulse-width-modulation (PWM) control. In PWM control, the electronic control unit 50 first performs coordinate conversion (three-phase-two-phase conversion) on the phase currents Iu, Iv, Iw of each phase of the motor 32 from the current sensors 32u, 32v, 32w using the electric angle θe based on the rotational position θm of the rotor of the motor 32 from the rotational position sensor 32a. Thus, the electronic control unit 50 calculates the current Id,Iq of the d-axis and the q-axis. Subsequently, the sensor error correction using the correction values ΔId and ΔIq is performed on the current Id,Iq of the d-axis and the q-axis to calculate the corrected currents Idco, Iqco of the d-axis and the q-axis. The correction values ΔId and ΔIq are parameters for correcting the current Id,Iq of the d-axis and the q-axis based on the sensor error (offset error or gain error) of the current sensors 32u, 32v, 32w. The correction values ΔId and ΔIq are part of various parameters related to the drive control of the motor 32. Details of the correction values ΔId and ΔIq will be described later. Then, the current commands Id*, Iq* of the d-axis and the q-axis are set based on the torque command Tm* of the motor 32. In addition, the electronic control unit 50 calculates the voltage commands Vd*, Vq* of the d-axis and the q-axis by the current feedback control so that the difference between the corrected currents Idco, Iqco of the d-axis and the q-axis and the current commands Id*, Iq * is canceled out. The electronic control unit 50 performs coordinate conversion (two-phase-three-phase conversion) of the calculated d-axis and q-axis voltage commands Vd*, Vq* using the electric angle de of the motor 32. Thus, the electronic control unit 50 calculates the phase-voltage commands Vu*, Vv*, Vw of respective phases. The phase-voltage commands Vu*, Vv*, Vw of respective phases thus obtained are compared with a carrier wave (triangular wave) to generate a PWM signal of transistors T11-T16, and switching control of the transistors T11-T16 is performed using the generated PWM signal.

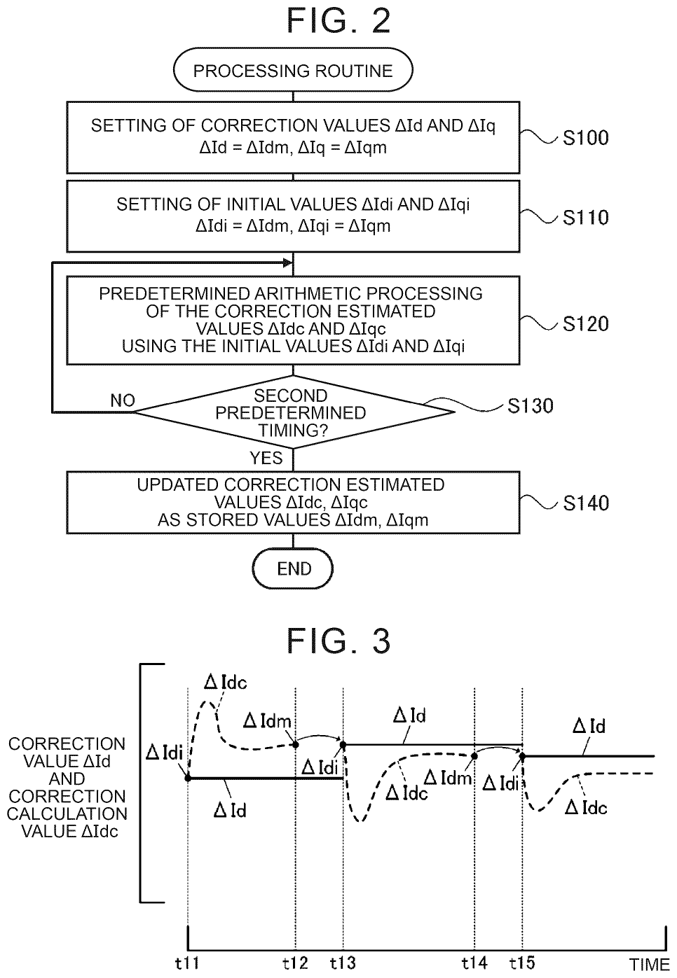

Here, details of the correction values ΔId and ΔIq will be described. FIG. 2 is a flow chart showing an exemplary process routine executed by CPU 51 of the electronic control unit 50. The execution of this routine is started when the first predetermined timing is reached. Here, as the first predetermined timing, a timing at which the power switch 60 is turned on (a timing at which a system start of the vehicle is instructed) is used.

When the process of FIG. 2 is executed, CPU 51 first sets the stored values ΔIdm and ΔIqm stored in the flash memory 54 to the correction value ΔId and ΔIq (S100). Here, the stored values ΔIdm and ΔIqm are set to nominal values (designed values) ΔId0 and ΔIq0, which are determined in advance immediately after the manufacturing of the vehicles, and are then updated by a process of S140 described later. As described above, the correction values ΔId and ΔIq are used for drive control of the motor 32. Specifically, the correction values ΔId and ΔIq are used for calculating the corrected currents Idco, Iqco of the d-axis and the q-axis by performing the sensor error correction using the correction values ΔId and ΔIq with respect to the current Id,Iq of the d-axis and the q-axis.

Subsequently, CPU 51 sets the stored values ΔIdm and ΔIqm to the initial values ΔIdi and ΔIqi (S110). CPU 51 performs the estimation processing for this time for the correction estimated values ΔIdc and ΔIqc related to the correction values ΔId and ΔIq using the set initial values ΔIdi and ΔIqi (S120). Here, as the estimation processing for the correction estimated value ΔIdc and ΔIqc, for example, regression analysis, smoothing processing, and the like can be exemplified. Examples of the regression analysis include a least squares method, a nonlinear least squares method, and the like. Examples of the smoothing process include a Kalman filter. Since the specific calculation methods of the correction estimated value ΔIdc and ΔIqc are well known, detailed description thereof will be omitted.

Then, CPU 51 determines whether or not the second predetermined timing has been reached (S130), and returns to S120 when it is determined that the second predetermined timing has not been reached. Here, as the second predetermined timing, a timing at which the power switch 60 is turned off (a timing at which a system stop of the vehicle is instructed) is used. When it is determined that the second predetermined timing has been reached by S130, CPU 51 stores the corrected estimated values ΔIdc and ΔIqc at that time as the stored values ΔIdm and ΔIqm in the flash memory 54. Accordingly, CPU 51 updates the stored values ΔIdm and ΔIqm (S140). CPU 51 terminates the routine.

Here, a sensor error (an offset error or a gain error) of the current sensors 32u, 32v, 32w depends on a manufacturing variation of the current sensors 32u, 32v, 32w, a secular change, and the like. It is assumed that a steep change is unlikely to occur, specifically, at an interval between the first predetermined timing and the second predetermined timing, and at an interval between the previous first predetermined timing and the first predetermined timing for this time, a gradual change characteristic (a change characteristic in which a change rate, which is a change amount per unit time, is equal to or less than a predetermined change rate) is provided. Therefore, the correction values ΔId and ΔIq based on the sensor error of the current sensors 32u, 32v, 32w are parameters that are assumed to be less likely to cause a steep change. Therefore, when the correction values ΔId and ΔIq are sequentially updated (frequently updated), there is a possibility that, for example, the correction values ΔId and ΔIq are updated to a value having a large error, and consequently, the stability of the drive control of the motor 32 is deteriorated. In contrast, in the embodiment, the correction values ΔId and ΔIq are updated every time the first predetermined timing is reached. That is, the correction values ΔId and ΔIq are held from the current first predetermined timing for this time to the next first predetermined timing. Accordingly, it is possible to suppress a decrease in the stability of the drive control of the motor 32. In addition, the estimation processing this time for this time for the correction estimated values ΔIdc and ΔIqc is performed by using the stored values ΔIdm and ΔIqm as the initial values ΔIdi and ΔIqi. As a result, it is possible to suppress the time required for the correction estimated values ΔIdc and ΔIqc to converge in the estimation processing for this time from becoming longer.

FIG. 3 is an explanatory diagram illustrating an example of the state of the correction value ΔId and the correction estimated value ΔIdc. Although not illustrated, the correction value ΔIq and the correction estimated value ΔIqc can also be considered in the same manner as the correction value ΔId and the correction estimated value ΔIdc. In the drawing, the times t11, t13, t15 is a first predetermined timing (a timing at which the system start of the vehicle is instructed), and the times t12, t14 are a second predetermined timing (a timing at which the system stop of the vehicle is instructed). That is, the times t11-t12, t13-t14, t15—correspond to the respective trips. As shown in the figure, when the first predetermined timing is reached (times t11, t13, t15), the stored values ΔIdm and ΔIqm are set to the correction values ΔId and ΔIq. The estimation processing for the correction estimated values ΔIdc and ΔIqc is executed using the stored values ΔIdm and ΔIqm as the initial values ΔIdi and ΔIqi. After that, when the second predetermined timing is reached (times t12, t14), the corrected estimated values ΔIdc and ΔIqc are set to the stored values ΔIdm and ΔIqm, and the stored values ΔIdm and ΔIqm are updated. During the estimation processing for the correction estimated values ΔIdc and ΔIqc, the correction estimated values ΔIdc and ΔIqc may vary relatively greatly. Therefore, when the correction values ΔId and ΔIq are sequentially updated by using the correction estimated values ΔIdc and ΔIqc, there is a possibility that the correction values ΔId and ΔIq suddenly change. This leads to a decrease in the stability of the drive control of the motor 32. On the other hand, in the embodiment, by holding the correction values ΔId and ΔIq from the first predetermined timing for this time to the first predetermined timing of the next time, successive updating (frequent updating) of the correction values ΔId and ΔIq is avoided. This suppresses a decrease in stability of the drive control of the motor 32. In the estimation processing for this time for the correction estimated values ΔIdc and ΔIqc, the stored values ΔIdm and ΔIqm in which the correction estimated values (previous ΔIdc) and (previous ΔIqc) in the previous estimation processing are set are used as the initial values ΔIdi and ΔIqi. As a result, it is possible to suppress the time required for the correction estimated values ΔIde and ΔIqc to converge in the estimation processing for this time from becoming longer than when the nominal values ΔId0 and ΔIq0 are used as the initial values ΔIdi and ΔIqi each time.

In the electronic control unit 50 mounted on battery electric vehicle 20 of the present embodiment described above, CPU 51 sets the stored values ΔIdm and ΔIqm to the correction values ΔId and ΔIq when the first predetermined timing is reached. CPU 51 performs an estimation processing for the corrected estimated values ΔIdc and ΔIqc by using the stored values ΔIdm and ΔIqm as the initial values ΔIdi and ΔIqi. After that, when the second predetermined timing is reached, the stored values ΔIdm and ΔIqm are updated by storing the correction estimated values ΔIdc and ΔIqc as the stored values ΔIdm and ΔIqm in the flash memory 54. As a result, it is possible to avoid the sequential updating (frequent updating) of the correction values ΔId and ΔIq, and to suppress a decrease in the stability of the drive control of the motor 32. In addition, it is possible to suppress the time required for the correction estimated values ΔIdc and ΔIqc to converge in the estimation processing from becoming longer.

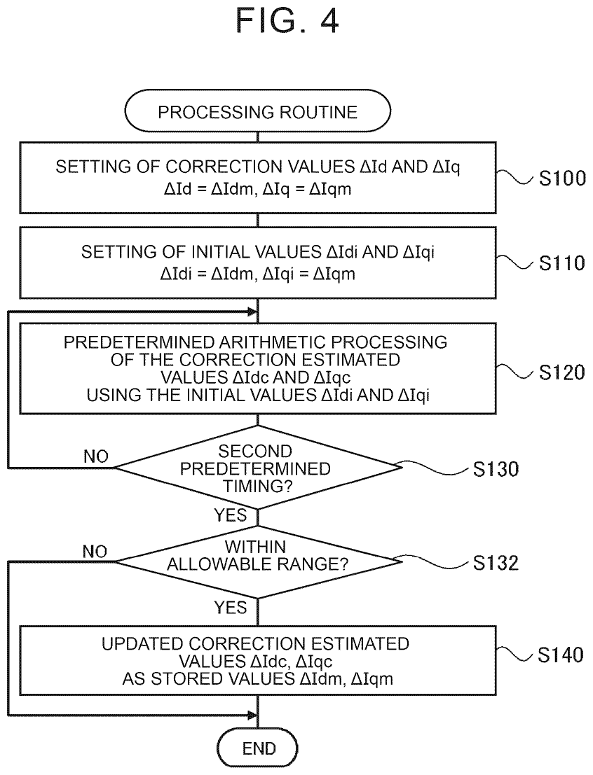

In the above-described embodiment, CPU 51 stores the corrected estimated values ΔIdc and ΔIqc as the stored values ΔIdm and ΔIqm in the flash memory 54 when the second predetermined timing is reached, as illustrated in the process routine of FIG. 2. Accordingly, CPU 51 updates the stored values ΔIdm and ΔIqm. Without limitation For example, CPU 51 may execute the processing routine of FIG. 4 instead of the processing routine of FIG. 2. The processing routine of FIG. 4 differs from the processing routine of FIG. 2 in that S132 processing is added. In the processing routine of FIG. 4, when it is determined that S130 reaches the second predetermined timing, it is determined whether the corrected estimated values ΔIdc and ΔIqc in the estimation processing for this time are within the allowable range (S132). Here, as the allowable range, for example, a range that can be normally taken, a range of a predetermined change amount with respect to correction estimated values (previous ΔIdc) and (previous ΔIqc) in the previous estimation processing, and the like can be used. When it is determined that the correction estimated values ΔIdc and ΔIqc in the estimation processing for this time are within the allowable range, the correction estimated values ΔIdc and ΔIqc are stored as the stored values ΔIdm and ΔIqm in the flash memory 54 (S140), and the routine ends. On the other hand, when it is determined that the correction estimated values ΔIdc and ΔIqc in the estimation processing for this time are outside the allowable range, the present routine is ended without storing the correction estimated values ΔIdc and ΔIqc as the stored values ΔIdm and ΔIqm in the flash memory 54. As a result, it is possible to avoid setting an abnormal value to the stored values ΔIdm and ΔIqm.

In the above-described embodiment, CPU 51 uses, as the first predetermined timing, a timing at which the power switch 60 is turned on (a timing at which a system start of the vehicle is instructed). CPU 51 uses, as the second predetermined timing, a timing at which the power switch 60 is turned off (a timing at which a system-stop of the vehicle is instructed). Without being limited thereto. For example, CPU 51 may use, as the first predetermined timing, a timing at which the vehicle is stopped by operating the brake pedal 65 and/or a timing at which the torque command Tm * of the motor 32 crosses the threshold Tmref in addition to or in place of the timing at which the system activation of the vehicle is instructed. As the second predetermined timing, a timing at which a predetermined time has elapsed from the first predetermined timing (for example, about several minutes to several tens of minutes) may be used in addition to or instead of the timing at which the system stop of the vehicle is instructed.

In the above-described embodiment, the correction values ΔId and ΔIq are correction values based on the sensor error (offset error or gain error) of the current sensors 32u, 32v, 32w, but the present disclosure is not limited thereto. For example, the correction values ΔId and ΔIq may be correction values based on only one of the offset error and the gain error of the current sensors 32u, 32v, 32w, or may be correction values based on the sensor error of the rotational position sensor 32a.

In the above-described embodiment, the battery 36 is used as the power storage device, but the present disclosure is not limited thereto. For example, a capacitor may be used as the power storage device.

In the above-described embodiment, the electronic control unit 50 as the control device is mounted on a battery electric vehicle 20 including the traction motor 32 and the inverter 34 that drives the traction motor. For example, the control device may be mounted on a hybrid electric vehicle that further includes an engine in addition to a hardware configuration similar to that of battery electric vehicle 20. The control device may be mounted on a fuel cell electric vehicle that further includes a fuel-cell in addition to a hardware configuration similar to battery electric vehicle 20.

The correspondence between the main elements of the embodiments and the main elements of the disclosure described in the column of the means for solving the problem will be described. In the embodiment, CPU 51 corresponds to the “processing unit” and the flash memory 54 corresponds to the “storage unit”.

The correspondence between the main elements of the embodiment and the main elements of the disclosure described in the section of the means for solving the problem is an example for specifically explaining the embodiment of the disclosure described in the section of the means for solving the problem. It is not intended to limit the elements of the disclosure described in the Means for Solving the Problem section. That is, the interpretation of the disclosure described in the section of the means for solving the problem should be performed based on the description in the section, and the embodiments are only specific examples of the disclosure described in the section of the means for solving the problem.

Although the embodiments for carrying out the present disclosure have been described using the embodiments, it is needless to say that the present disclosure is not limited to such embodiments, and can be implemented in various forms without departing from the gist of the present disclosure.

The present disclosure is applicable to a manufacturing industry of a control device and the like.

What is claimed is:

1. A control device installed in a vehicle equipped with a traction motor, the control device comprising: a processing unit; and a storage unit, wherein the processing unit,
upon reaching a first predetermined timing, sets a stored value that is stored in the storage unit to a predetermined parameter related to drive control of the motor, and also executes estimation processing for this time regarding an estimated value related to the predetermined parameter, using the stored value as an initial value, and
upon reaching a second predetermined timing, the estimated value in the estimation processing for this time is stored in the storage unit as the stored value.

2. The control device according to claim 1, wherein upon reaching the second predetermined timing, the processing unit stores the estimated value as the stored value in the storage unit when the estimated value in the estimation processing for this time is within an allowable range, and does not store the estimated value in the storage unit when the estimated value in the estimation processing for this time is outside the allowable range.

3. The control device according to claim 1, wherein:
the first predetermined timing includes at least one of a timing at which system booting of the vehicle is instructed, a timing at which the vehicle is stopped by a brake operation, and a timing at which a torque command used for drive control of the motor crosses a torque threshold; and
the second predetermined timing includes at least one of a timing at which system shutdown of the vehicle is instructed, and a timing at which a predetermined time elapsed from the first predetermined timing.

4. The control device according to claim 1, wherein the predetermined parameter is a correction value based on at least one of a gain error of a current sensor that detects a phase current of each phase of the motor, and an offset error of the current sensor.
